(19) United States
(12) Patent Application Publication
(10) Pub. No.: US 2002/0192415 A1
(43) Pub. Date: Dec. 19, 2002

(54) Stack of adhesive articles

(75) Inventors: Gerald L. Vogler, Woodbury, MN (US); James R. Carter, JR., Woodbury, MN (US)

Correspondence Address: Office of Intellectual Property Counsel, 3M Innovative Properties Company, PO Box 33427, St. Paul, MN, 55133-3427, US

(73) Assignee: 3M Innovative Properties Company

(21) Appl. No.: 09/882,785

(22) Filed: Jun. 15, 2001

(51) Int. Cl. B32B 7/06

(52) U.S. Cl. 428/40.1

(57) ABSTRACT

A stack of adhesive articles. The stack of adhesive articles has a plurality of carried adhesive articles with each carried adhesive article including a carrier sheet and an adhesive article releasably adhered to the carrier sheet, and in which each carried adhesive article is releasably adhered by to the carrier sheet of an adjacent carried adhesive article.

### TECHNICAL FIELD

The present invention relates generally to a stack of adhesive articles. The present invention relates more particularly to a plurality of carried adhesive articles, in which each carried adhesive article includes a carrier sheet and an adhesive article releasably adhered to the carrier sheet, and in which each carried adhesive article is releasably adhered to the carrier sheet of an adjacent carried adhesive article.

### BACKGROUND OF THE INVENTION

Various adhesive articles having carrier sheets are commonly used to join two substrates or objects together. One adhesive article is the 3M™ Repulpable Nose Tabs 9030, which is commercially available from Minnesota Mining and Manufacturing based in St. Paul, Minn. The repulpable nose tab includes an adhesive layer releaseably adhered between two opposing paper liners. The adhesive layer has a first layer of adhesive, a second layer of adhesive, and a tissue located between the first and second layer of adhesive. The repulpable nose tabs are typically used to adhere the outside leading edge of a roll of paper to an inner lap of the same roll of paper. To use the repulpable nose tab, a user removes the first liner from the layer of adhesive, orients the exposed layer of adhesive towards the inner lap of paper, applies the exposed layer of adhesive to the inner lap of paper, removes the second liner from the other side of the adhesive to expose the other side of adhesive, and adheres the outer lap of paper to that exposed layer of adhesive layer.

Another adhesive article is the 3M™ Repulpable Paster Tapes 9069 and 913, which are commercially available from Minnesota Mining and Manufacturing based in St. Paul, Minn. These paster tapes include an adhesive layer releaseably adhered to a paper tape liner. The adhesive layer has a first layer of adhesive, a second layer of adhesive, and a tissue located between the first and second layer of adhesive. The repulpable paster tapes are typically used adhere the outside leading edge of a roll of paper to an inner lap of the same roll of paper. To use the repulpable paster tapes, a user cuts off a length of tape from the roll of tape, orients the exposed layer of adhesive towards the inner lap of paper, applies the exposed layer of adhesive to the inner lap of paper, removes the paper tape liner, and adheres the outer lap of paper to the other side of the adhesive layer.

U.S. Pat. No. 4,842,919, “Pad Forming Method,” (David et al.) describes a method for forming pads of pressure sensitive adhesive coated sheets with similar discontinuities (e.g., printed indicia or openings) on the sheets substantially aligned. A strip of pressure sensitive adhesive coated material is helically wound around the periphery of the roller to form a roll comprising a multiplicity of overlying layers of the strip by rotating the roller about its axis to pull the strip along a predetermined path onto the roller. Discontinuities are formed on the strip along the predetermined path at locations that are progressively increasingly spaced apart to compensate for the increasing circumference of the roll and which result in at least one set of discontinuities being located along the periphery of the roller in substantial alignment radially outwardly of the roller and pads containing such aligned discontinuities are then cut from the roll.

U.S. Pat. No. 5,827,591, “Removable Adhesive Notes for an Industrial Setting,” (Blok et al.) describes pads for posting removeable adhesive sheets. The pads comprise a stack of a plurality of adhesive sheets having release sheets adhered to the back of each, wherein each adhesive sheet, when applied to a surface, is removable without leaving an adhesive residue. The adhesive sheets comprise a flexible polymer film, polymer-reinforced sheet or cloth having a Taber stiffness of not less than 0.03 measured according to ASTM D747, a front side capable of receiving markings and a back side substantially covered with a pressure sensitive adhesive having an initial tack value of at least 200 g measured according to ASTM D2979 on a Polyken™ probe tack tester, an adhesive tack sufficient to prevent conformability failure of the adhesive sheet after 10 hours conformability testing, and an adhesive strength of at least 100 N/m according to ASTM D1000 and each release sheet covers at least 50 percent of the pressure sensitive adhesive on the back of each adhesive sheet. This patent also describes a process for making such pads and a kit for dispensing adhesive sheet/release sheet combinations.

### SUMMARY OF THE INVENTION

One aspect of the present invention is a stack of adhesive articles. The stack of adhesive articles comprises: a) a first carrier sheet; b) a first adhesive article releaseably adhered to the first carrier sheet; c) a second carrier sheet releaseably adhered to the first adhesive article opposite the first carrier sheet; d) a second adhesive article releaseably adhered to the second carrier sheet opposite the first adhesive article; and e) a third carrier sheet releaseably adhered to the second adhesive article opposite the second carrier sheet. In a preferred embodiment of the above stack of adhesive articles, the first adhesive article is an adhesive layer. In another aspect of this embodiment, the adhesive layer comprises a pressure-sensitive adhesive. In another aspect of this embodiment, the adhesive layer is a reinforced adhesive layer. In yet another aspect of this embodiment, the reinforced adhesive includes fibers therein. In another aspect of this embodiment, the reinforced adhesive layer includes a first adhesive layer, a second adhesive layer, and a non-woven layer between the first adhesive layer and the second adhesive layer. In yet another aspect of this embodiment, the reinforced adhesive layer includes a first adhesive layer, a second adhesive layer, and a layer of film between the first adhesive layer and the second adhesive layer.

In another preferred embodiment of the above stack of adhesive articles, the stack of adhesive articles further comprises a first tab releasably adhered to the first adhesive article. In another preferred embodiment of the above stack of adhesive articles, the first carrier sheet and the second carrier sheet extend beyond the first adhesive article, and where the second carrier sheet and the third carrier sheet extend beyond the second adhesive article. In yet another preferred embodiment of the above stack of adhesive articles, the first adhesive article is adhered more strongly to the first carrier sheet than to the second carrier sheet.

In another preferred embodiment of the above stack of adhesive articles, when the first carrier sheet is removed from the stack of adhesive articles, the first adhesive article separates from the second carrier sheet and remains releasably adhered to the first carrier sheet. In another aspect of this embodiment, where when the second carrier sheet is removed from the stack of adhesive articles, the second adhesive article separates from the third carrier sheet and remains releasably adhered to the second carrier sheet.

In yet another preferred embodiment of the above stack of adhesive articles, the first carrier sheet is a first release sheet and second carrier sheet is a second release sheet. In another aspect of this embodiment, the first release sheet and second release sheet include a release coating thereon. In another aspect of this embodiment, the first release sheet and the second release sheet both include a first major surface and a second major surface opposite the first major surface, and where the first major surface and the second major surface include a release coating thereon.

Another aspect of the present invention provides an alternative stack of adhesive articles. This stack of adhesive articles comprises a plurality of carried adhesive articles, where each carried adhesive article includes a carrier sheet and an adhesive article releasably adhered to the carrier sheet, and where each carried adhesive article is releasably adhered to the carrier sheet of an adjacent carried adhesive article. In a preferred embodiment of the above stack of adhesive articles, each of the adhesive articles is an adhesive layer. In another aspect of this embodiment, each of the adhesive layers comprises a pressure-sensitive adhesive. In another aspect of this embodiment, each of the adhesive layers is a reinforced adhesive. In another aspect of this embodiment, the reinforced adhesive layer includes fibers therein. In yet another aspect of this embodiment, the reinforced adhesive layer includes a first adhesive layer, a second adhesive layer, and a non-woven layer between the first adhesive layer and the second adhesive layer. In yet another aspect of this embodiment, the reinforced adhesive layer includes a first adhesive layer, a second adhesive layer, and a layer of film between the first adhesive layer and the second adhesive layer.

In another preferred embodiment of the above stack of adhesive articles, each of carried adhesive articles further comprises a tab releasably adhered to the adhesive article. In another preferred embodiment of the above stack of adhesive articles, each of the carrier sheets extends beyond the adhesive article. In yet another preferred embodiment of the above stack of adhesive articles, the releasable bond between the carrier sheet and the adhesive article is stronger than the releasable bond between adjacent carried adhesive articles. In another preferred embodiment of the above stack of adhesive articles, each of the carrier sheets is a release sheet, and where the release sheet includes a release coating thereon. In another aspect of this embodiment, the release sheet includes a first major surface and a second major surface opposite the first major surface, and where the first major surface and the second major surface include a release coating thereon.

Another aspect of the present invention provides a method of applying an adhesive article to a surface. This method of applying an adhesive article to a surface comprises: a) providing a stack of carried adhesive articles, comprising: i) a first carrier sheet; ii) a first adhesive article releaseably adhered to the first carrier sheet; iii) a second carrier sheet releaseably adhered to the first adhesive article opposite the first carrier sheet; iv) a second adhesive article releaseably adhered to the second carrier sheet opposite the adhesive article; and v) a third carrier sheet releaseably adhered to the second adhesive article opposite the second carrier sheet; b) removing the first carrier sheet and the first adhesive article together from the second carrier sheet; c) adhering the first adhesive article to a surface; and d) thereafter separating the first carrier sheet from the first adhesive article on the surface.

In a preferred embodiment of the above method, the method further comprises: e) removing the second carrier sheet and the second adhesive article together from the third carrier sheet; f) adhering the second adhesive article to the surface; and g) thereafter separating the second carrier sheet from the second adhesive article on the surface.

Another aspect of the present invention provides an alternative method of applying an adhesive article to a surface. This method of applying an adhesive article to a surface comprises: a) providing a plurality of carried adhesive articles, where each carried adhesive article includes a carrier sheet and an adhesive article releasably adhered to the carrier sheet, where each carried adhesive article is releasably adhered to the carrier sheet of an adjacent carried adhesive article; b) removing one of the plurality of carried adhesive articles from the plurality of carried adhesive articles; c) adhering the adhesive article to a surface; and d) thereafter separating the carrier sheet from the adhesive article on the surface. In a preferred embodiment of the above method, the method further comprises: e) removing another of the plurality of carried adhesive articles from the plurality of carried adhesive articles; f) adhering the adhesive article to a surface; and g) thereafter separating the carrier sheet from the adhesive article on the surface.

Yet another aspect of the present invention provides another method of applying an adhesive article to a surface. This method of applying a adhesive article to a surface, comprises: a) providing a stack of adhesive articles, comprising: i) a first carrier sheet; ii) a first adhesive article releaseably adhered to the first carrier sheet; iii) a second carrier sheet releaseably adhered to the first adhesive article opposite the first carrier sheet; iv) a second adhesive article releaseably adhered to the second carrier sheet opposite the adhesive article; and v) a third carrier sheet releaseably adhered to the second adhesive article opposite the second carrier sheet; b) removing the first carrier sheet from the first adhesive article; c) adhering the first adhesive article of the stack of carried adhesive articles to a surface; and d) thereafter separating the stack of carried adhesive articles from the first adhesive article on the surface. In a preferred embodiment of the above method, the method further comprises: e) removing the second carrier sheet from the second adhesive article; f) adhering the second adhesive article of the stack of carried adhesive articles to the surface; and g) thereafter separating the stack of carried adhesive articles from the second adhesive article on the surface.

### BRIEF DESCRIPTION OF THE DRAWINGS

The present invention will be further explained with reference to the appended Figures, wherein like structure is referred to by like numerals throughout the several views, and wherein:

FIG. 1 is a cross-sectional view of a stack of adhesive articles of the present invention;

FIG. 2 is the stack of adhesive articles of FIG. 1, illustrating one of the carried adhesive articles being partially removed from the rest of the stack of adhesive articles;

FIG. 3 illustrates applying the carried adhesive article to a surface;

FIG. 4 illustrates separating the carrier sheet from the adhesive article on the surface;

FIG. 5 illustrates the adhesive article on the surface, after the carrier sheet has been removed;

FIG. 6a illustrates an alternative carried adhesive article;

FIG. 6b illustrates another alternative carried adhesive article;

FIG. 7 is a schematic view of an apparatus for making the stack of adhesive articles of FIG. 1;

FIG. 8 illustrates a top view of the apparatus of FIG. 7;

FIG. 9 illustrates removing the spirally wound webs from the roller;

FIG. 10 illustrates the spirally wound webs after they have been removed from the roller and flattened out, prior to cutting them into stacks of carried adhesive articles;

FIG. 11 illustrates the stacks of carried adhesive articles after they have been cut; and

FIG. 12 is a schematic view of an alternative apparatus for making the stack of adhesive articles of FIG. 6b; and

FIG. 13 illustrates a top view of the apparatus of FIG. 12.

### DETAILED DESCRIPTION OF THE INVENTION

The present invention provides a stack of carried adhesive articles. This stack of carried adhesive articles may be sized to conveniently fit into a shirt pocket or apron pocket of a user. The user may first remove one of the carried adhesive articles from rest of the stack of carried adhesive articles, and easily apply it to a surface. Once the adhesive article is applied to the surface, the user may remove the carrier sheet and apply a second substrate to the adhesive article. The stack of carried adhesive articles of the present invention is an improvement over the individual carried adhesive articles described in the background as the repulpable nose tabs, in that the individual repulpable nose tabs often spill out onto the floor, like a deck of cards, when trying to remove them from a container. Additionally, the stack of carried adhesive articles of the present invention eliminates the need to remove an extra release sheet prior to adhering the adhesive article to the surface and reduces the costs for including the extra release sheet.

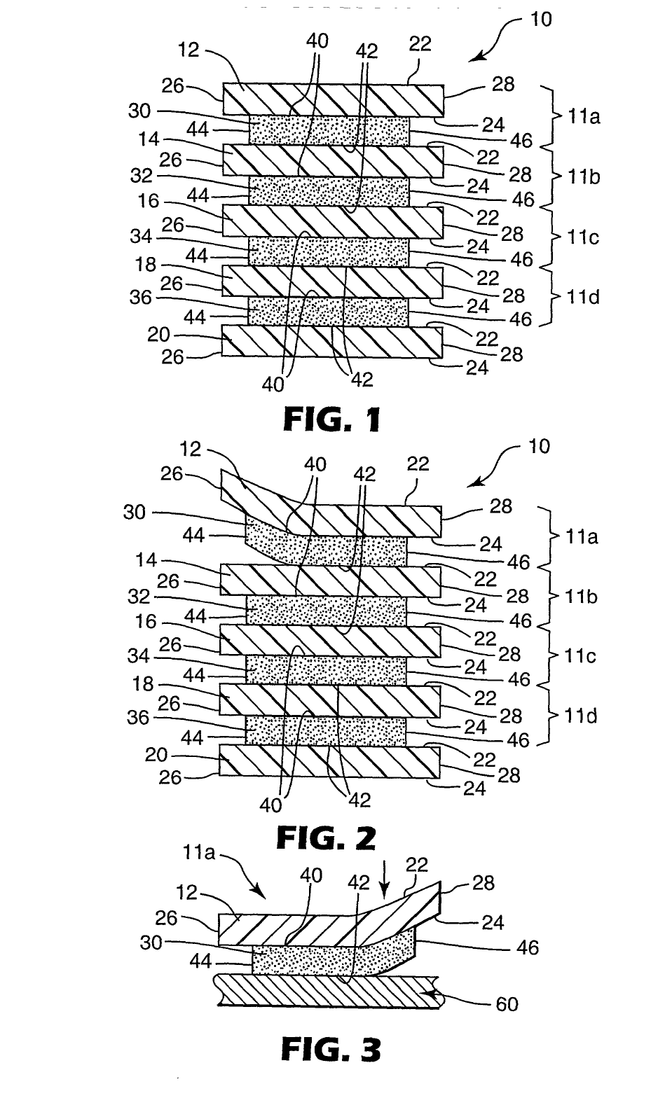

FIG. 1 illustrates one preferred embodiment of the stack of carried adhesive articles 10 of the present invention. The stack of carried adhesive articles 10 includes a plurality of carried adhesive articles 11. Each carried adhesive article includes a carrier sheet and an adhesive article. The stack 10 in FIG. 1 is illustrated as including four carried adhesive articles 11a, 11b, 11e, and 11d. However, the stack 10 may include more or fewer carried adhesive articles 11. Each carried adhesive article 11 is releasably adhered to the adjacent carried adhesive article. For instance, a first carried adhesive article 11a is releasably adhered to a second carried adhesive article 11b, the second carried adhesive article 11b is releasably adhered to third carried adhesive article 11c, and so on. A fourth carried adhesive article 11d is releaseably adhered to the last carrier sheet 20 in the stack 10. The last carrier sheet 20 may be a preprinted back sheet.

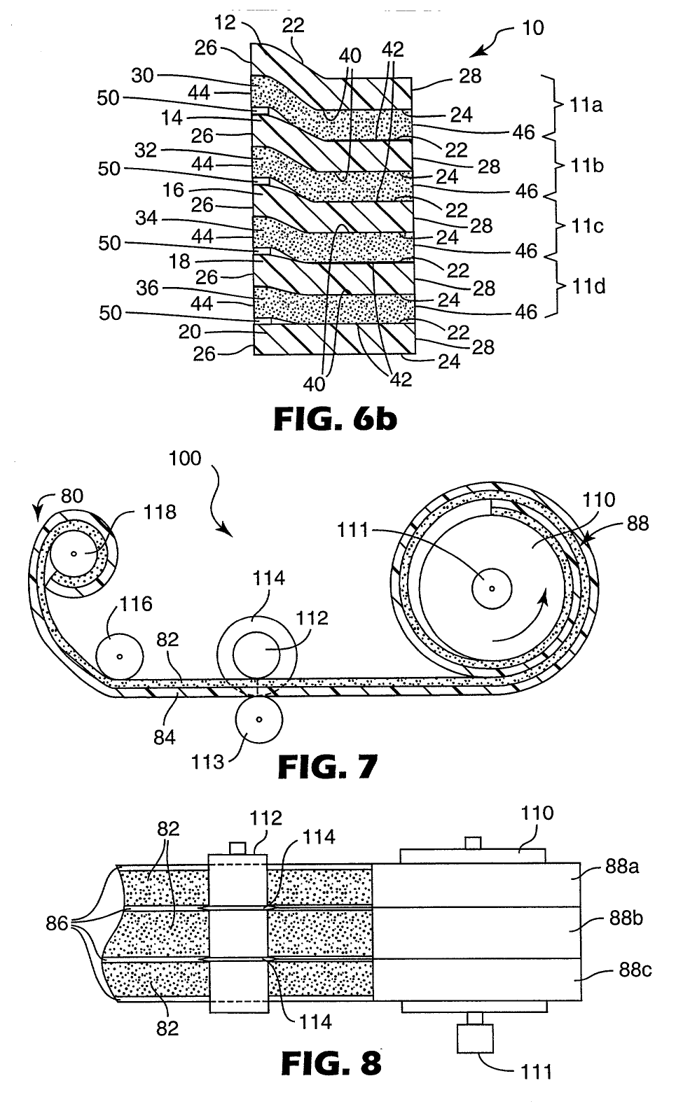

The stack 10 is illustrated as including a first carrier sheet 12, a second carrier sheet 14, a third carrier sheet 16, a fourth carrier sheet 18, and a fifth carrier sheet 20. However, the stack of carried adhesive articles 10 may include any number of carrier sheets, depending on how many carried adhesive articles 11 the stack 10 includes. Each carrier sheet includes a first major surface 22 and a second major surface 24 opposite the first major surface 22. The carrier sheet also includes a first end 26 extending between the first major surface 22 and the second major surface 24. The carrier sheet includes a second end 28 opposite the first end 26, which also extends between the first major surface 22 and the second major surface 24 of the carrier sheet. The stack is illustrated as including a first adhesive article 30, a second adhesive article 32, a third adhesive article 34, and a fourth adhesive article 36. However, the stack of carried adhesive articles 10 may include any number of adhesive articles, depending on how many carried adhesive articles 11 the stack 10 includes. Each adhesive article includes a first major surface 40 and a second major surface 42 opposite the first major surface 40. The adhesive article also includes a first end 44 extending between the first major surface 40 and the second major surface 42. The adhesive article includes a second end 46 opposite the first end 44, which also extends between the first major surface 40 and the second major surface 42 of the adhesive article. The adhesive articles 30-36 are illustrated in FIG. 1 as a single layer of adhesive. However, the adhesive article may be any article that has adhesive on both the first and second major surfaces. The adhesive article could alternatively include multiple layers of adhesive or other reinforcing layers, as illustrated in FIG. 6a.

The carried adhesive articles II are illustrated as including a carrier sheet that extends beyond the adhesive article. In other words, at least the first end 26 of the carrier sheet extends beyond the first end 44 of the adhesive article. Preferably, the second end 28 of the carrier sheet also extends beyond the second end 46 of the adhesive article, however this is not required. This is to allow a user to easily grasp the edge of the carrier sheet and to remove the carried adhesive article 11 from the stack and then to later remove the carrier sheet from the adhesive article as described below. Alternatively, the stack 10 may include carrier sheets having the first end 26 of the first carrier sheet 12 extending beyond the first end 44 of the first adhesive article 30 and having the second end 28 of the second carrier sheet 14 extending beyond the second end 26, and so on. In addition, the ends 40, 42 of the adhesive article may alternatively be flush with the ends 26, 28 of the carrier sheet, as illustrated in FIG. 6b.

As mentioned above, the carried adhesive articles 11 are releaseably adhered to one another. Specifically, the adhesive article of one carried adhesive article 11 is releasably adhered to the carrier sheet of an adjacent carried adhesive article 11. The last carried adhesive article 11d in the stack 10 is releasably adhered to the last carrier sheet 20 in the stack 10. For example, the second major surface of the first adhesive article 30 of the first carried adhesive article 11a is releasably adhered to first major surface of the second carrier sheet 14 of the second carried adhesive article 11b. In addition, the first major surface of the adhesive article 30 of the first carried adhesive article 11a is releasably adhered to the second major surface 24 of the first carrier sheet 12. The term “releasably adhered” as used throughout this application, including the claims, means that the two items, such as the adhesive article and carrier sheet, are adhered to one another, yet are capable of being separated from each other during normal use, such as a user separating the two items by hand, so that the adhesive article remains in tact and may be applied to a surface. Preferably, no complicated mechanical apparatus or chemicals are needed to releasably separate the two items.

FIG. 2 illustrates one of the carried adhesive articles 11 partially removed from the top of the stack 10. Specifically, the first carried adhesive article 11a is being removed from the second carried adhesive article 11b. Preferably, the first adhesive article 30 is releasably adhered more strongly to the first carrier sheet 12 than to the second carrier sheet 14, so that when the first carrier sheet is grasped by a user, the adhesive article 30 separates from the second carrier sheet 14 and at the same time remains releasably adhered to the first carrier sheet 12. Another way of expressing this preferential release is to say that there is a first releasable bond between the first major surface 40 of the first adhesive article 30 and the second major surface 24 of the first carrier sheet 12. There is a second releasable bond between the second major surface 42 of the adhesive article and the first major surface 22 of the second carrier sheet 14. Preferably, the first releasable bond is stronger than the second releasable bond, so that when a carried adhesive article 11 is removed from the rest of the stack 10 by grasping the first carrier sheet, the carrier sheet and adhesive article remain together. Once the carried adhesive article 11a is removed from the stack 10, the user may orient the adhesive article to apply the carried adhesive sheet to a surface, as illustrated in FIG. 3.

FIG. 3 illustrates the carried adhesive article 11a as it is being applied to a surface 60. The second major surface 42 of the adhesive article 30 is adhered to surface 60. Once the adhesive article is adhered to the surface, the carrier sheet 12 may then be removed from the adhesive article 30, as illustrated in FIG. 4. Preferably, the adhesive article 30 is adhered more strongly to the surface 60 than to the carrier sheet 12. In other words, there is a third bond between the second major surface 42 of the first adhesive article 30 and the surface 60. This third bond is stronger than the second releasable bond described above, which is between the first major surface 40 of the first adhesive article 30 and the second major surface 24 of the first carrier sheet 12. Preferably, the bond between the second major surface 42 of the first adhesive article 30 and the surface 60 is “permanent,” in contrast with “releasable,” meaning that once applied, the adhesive article can not be removed in one continuous piece and then moved to another location for application. However, in some cases it might be preferable that the adhesive article can be removed from the surface and then reapplied to another portion of the surface.

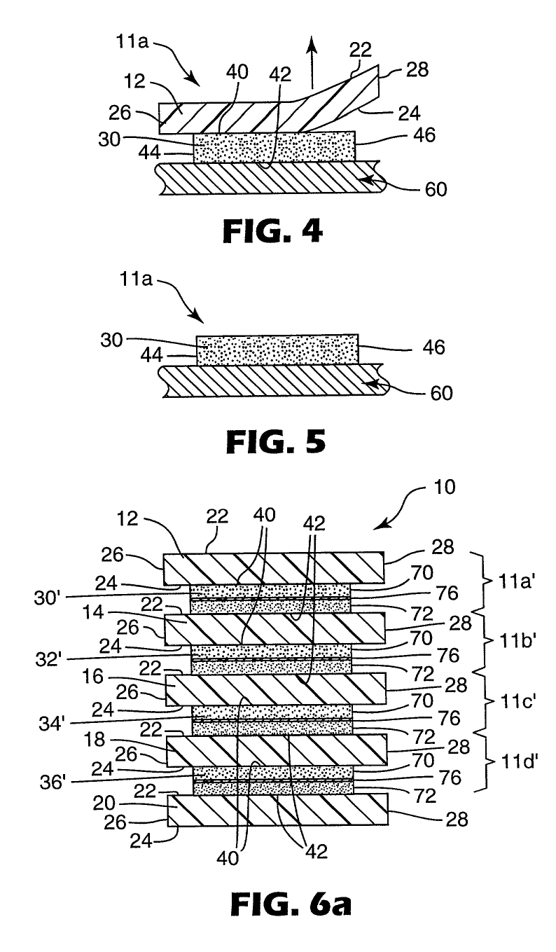

FIG. 5 illustrates the first adhesive article 30 after the first carrier sheet 12 has been removed. After the carrier sheet has been removed, a user may adhere a substrate, such as paper, plastic, cardboard, or metal, to the first major surface 40 of the adhesive article. For example, if a flap of a cardboard carton became unsealed from the rest of the carton, a user could apply the carried adhesive article 11 under the flap, remove the carrier sheet, and then close the flap down onto the adhesive article to reseal the carton. As another example, a user could apply the carried adhesive article 11 to adhere the outside leading edge of the a roll of paper to an inner lap of the same roll of a paper by first applying the carried adhesive article to the inner lap of paper, removing the carrier sheet, and then adhering the outer lap of the paper to the adhesive article.

After the first carried adhesive article 11a is removed from the stack 10, then the second carried adhesive article 11b may be removed from the stack 10 by grasping the second carrier sheet and applying it to another surface, following the description above. This process will continue until there are no more carried adhesive articles 11 left in the stack, leaving the last carrier sheet 20 at the bottom of the stack 10.

In an alternative embodiment of the stack of carried adhesive articles, a user may remove the first carrier sheet 12, leaving the first adhesive article 30 adhered to the second carrier sheet, apply the first adhesive article 30 in the stack 10 to a surface by applying the stack to the surface oriented such that the first adhesive article adheres to the surface, and then remove the stack 10, leaving the adhesive article 30 behind adhered to the surface. (not illustrated) In this embodiment, the second major surface 42 of the first adhesive article 30 is more strongly adhered to the first major surface 22 of the second carrier sheet 14 than the first major surface 40 is adhered to the second major surface 24 of the first carrier sheet 12. In other words, the second releasable bond (between the second major surface 42 of the adhesive article and the first major surface 22 of the second carrier sheet 14) is stronger than the first releasable bond (between the first major surface 40 of the first adhesive article 30 and the second major surface 24 of the first carrier sheet 12). In this embodiment, after the first adhesive article 30 is applied to the surface, then the second carrier sheet 14 may be removed from the stack 10 and the second adhesive article 32 may applied to another surface, following the description above. This process will continue until there are no more carried adhesive articles 11 left in the stack, leaving the last carrier sheet 20 at the bottom of the stack 10.

FIG. 6a illustrates a stack 10 of alternative carried adhesive articles 11′. These alternative carried adhesive article 11′ include the same carrier sheets described above, but include alternative adhesive articles 30′, 32′, 34′, 36′. The adhesive articles each include a first adhesive layer 70, a second adhesive layer 72, and a third layer 76 located between the first adhesive layer 70 and the second adhesive layer 72. The first adhesive layer 70 may include a different adhesive than the adhesive in the second adhesive layer. For example, the first adhesive layer 70 may include a repositionable pressure sensitive adhesive and the second adhesive layer 72 may include a non-repositionable pressure sensitive adhesive. As another example, the first layer 70 may be a rubber-based adhesive and the second layer 72 may be an acrylic-based adhesive. Alternatively, the first adhesive layer 70 and second adhesive layer 72 may include the same adhesive. The first and second layers of adhesives may be the same or different thicknesses. The third layer 76 serves to reinforce the adhesive article. Preferably the third layer 76 is a non-woven layer, such as tissue or scrim. Alternatively, the third layer 76 may be a layer of film, such as polyester, polypropylene, polyethylene, or vinyl . Alternatively, the third layer 76 may be a woven layer, a foam, or a metal composite.

FIG. 6b illustrates another stack 10 of alternative carried adhesive articles 11. The alternative carried adhesive articles 11 may include any of the carrier sheets and adhesives articles described herein, but also include an optional tab 50. The tab 50 is releasably adhered to the second major surface 42 of the adhesive articles. Preferably, the tab 50 is adjacent the first major surface of the carrier sheet, yet not adhered to the carrier sheet. The tab 50 helps initially separate the adhesive article of one carried adhesive article 11 from the carrier sheet of an adjacent carried adhesive article 11. Once the first carried adhesive article 11 is removed from the stack 10, the tab 50 is preferably removed from the first adhesive article 30 prior to adhering the first adhesive article 30 to surface. In this embodiment, the adhesive articles may be flush with the carrier sheets in each carried adhesive article 11. In other words, the ends 40, 42 of the adhesive article are flush with the ends 26, 28 of the carrier sheet.

The carrier sheets of the carried adhesive articles may be anything that functionally may carry an adhesive article. Preferably, the carrier sheets of the carried adhesive articles are release sheets. Some examples of suitable materials for the release sheets include commercially available papers or films. Other examples of suitable materials for the release liners are commercially available silicone coated release liners, olefin release liners, and textured or embossed films. To obtain the releasable bonds between the adhesive articles and the carrier sheets described above, the adhesive and the carrier sheet may be selected such that the adhesive in the adhesive articles releasably adheres to the carrier sheet without the need for any added release coatings. Alternatively, the carrier sheets may be coated with a release coating. The release coating may be on the first major surface 22 of the carrier sheet, on the second major surface 24 of the carrier sheet, or on both the first major surface 22 and second major surface 24 of the carrier sheet. The release coatings on the first major surface 22 and second major surface 24 of the carrier sheet may be the same or different. Suitable release coatings include coatings having silicone, urea silicones, alkyl acrylate, waxes, or fluorocarbon polymers. The adhesive article includes at least one layer of adhesive. Examples of suitable adhesives include pressure sensitive adhesives, heat activated adhesives, thermosetting adhesives and remoistenable adhesives. Particularly preferred adhesives include pressure sensitive adhesives that may be hot-melt adhesives, essentially solvent or water-free adhesives or solvent-or water-based dispersions or solutions. Specific pressure sensitive adhesives include acrylate-based pressure sensitive adhesives, styrene-isoprene block copolymers, acrylic ester-vinyl acetate copolymers, ethylene-vinyl acetate copolymers, plasticized vinyl acetate homopolymers and rubber-latex resin emulsion systems. In the practice of preferred embodiments of the invention, the adhesive composition comprises an acrylate-based pressure sensitive adhesive. Acrylate-based pressure sensitive adhesives useful in practicing the invention comprise polymers of one or more monomers of (meth)acrylic acids and optionally other copolymerizable monomers containing functional groups in addition to an ethylenically unsaturated group. The acrylate-based pressure sensitive adhesive may comprise conventional additives such as, for example, fillers, anti-oxidants, flame-retardants, pigments, tackifiers, plasticizers or polymer additives. By varying the nature and amount of the monomers and the nature and amount of the additives, the properties of the resulting adhesive can be changed as is known in the art.

Examples of acrylate-based pressure sensitive adhesives that are suitable in the practice of the invention are described in Satas, “Acrylic Adhesives,” Handbook of Pressure-Sensitive Adhesive Technology, 2nd ed., pp. 396-456 (D. Satas, ed.), Van Nostran Reinhold, New York (1989).

A particularly suitable acrylate based pressure sensitive adhesive includes copolymers of an acrylic or methacrylic acid and an alkyl acrylate or methacrylate wherein the alkyl group has at least 4 carbon atoms, typically 4 to 14 carbon atoms. Examples of such alkyl acrylates or methacrylates include n-butyl, n-pentyl, n-hexyl, cyclohexyl, isoheptyl, n-nonyl, n-decyl, isohexyl, isobornyl, 2-ethyloctyl, isooctyl, and 2-ethylhexyl acrylates and methacrylates. Preferred alkyl acrylates include isooctyl acrylate, 2-ethylhexyl acrylate, n-butylacrylate and cyclohexyl acrylate. A particularly preferred alkyl acrylate is isooctyl acrylate. Particularly preferred alkyl methacrylates include butyl methacrylate, cyclohexyl methacrylate, and isobornyl methacrylate.

In accordance with a highly preferred embodiment of this invention, the adhesive layer is a repulpable adhesive. A preferred repulpable adhesive for use in this invention has a rating of not more than 3 in the European repulpability test described in U.S. Pat. No. 5,380,779. Examples of repulpable adhesives for use in the invention include the repulpable adhesives disclosed in the following U.S. Pat. Nos. 5,380,779; 4,413,080; 4,569,960; 4,482,675; 4,388,432; 5,102,733; and 5,125,995. The thickness of the adhesive layer can be varied widely but is typically between 200 μm and 350 μm and preferably between 230 μm and 300 μm.

Alternatively, the layer of adhesive may preferably include reinforcing fibers, such as nylon, fiberglass or rayon.

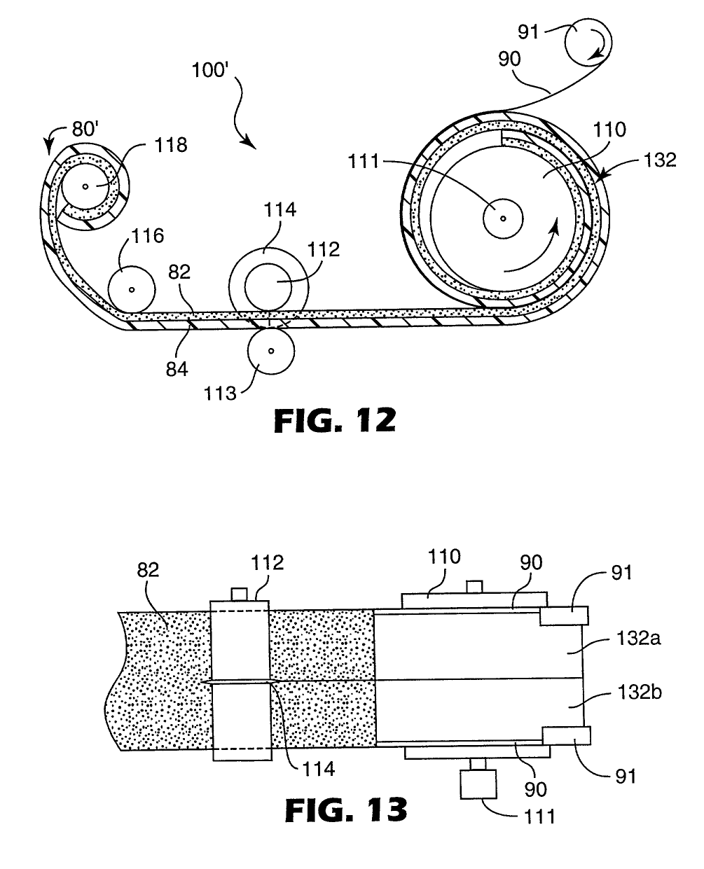

FIGS. 7-13 illustrate alternative methods of making the stack of carried adhesive articles. FIGS. 7 and 8 illustrate an apparatus 100 for making the stack of adhesive articles 10 illustrated in FIG. 1 and FIG. 6a. FIGS. 12 and 13 illustrate an alternative apparatus 100′ for making the stack of carried adhesive articles 10 illustrated in FIG. 6b.

In FIGS. 7 and 8, apparatus 100 includes a unwind roller 118, an idler roller 116, a slitting roller 112 that includes blades 114, a roller 113 opposite the slitting roller 112, and a wind-up roller 110. The starting material for making the stack of adhesive articles 10 is a web which is wound around the unwind roller 118. The unwind roller 118, idler roller 116, slitting roller 112, and roller 113 are all free rotating rollers. The wind-up roller 110 includes a drive motor 111, which pulls the web 80 through the apparatus 100. The idler roller is preferably covered by a release wrap (not shown) or coated with a release agent, so that the adhesive layer 82 does not stick to the idler roller 116.

The web 80 includes an adhesive layer 82 and a carrier layer 84. As illustrated in FIG. 8, the web includes a non-adhesive area 86 located between adjacent adhesive areas. In addition, the outer longitudinal edges of the web 80 preferably include non-adhesive areas 86. The non-adhesive areas 86 preferably do not include any adhesive. For example, the carrier sheet 84 may be zone coated with adhesive, as is known by one skilled in the art. However, the non-adhesive areas may include adhesive which has been made non-adhesive, for example by detackifying the adhesive by printing, as is known by one skilled in the art. Alternatively, the non-adhesive areas may be stamped or stripped out of the adhesive layer.

The web 80 is initially unwound from the unwind roller 118 and passed around idler roller 116. Next, the web is pulled through the nip formed between the blades 114 of slitting roller 112 and the opposing roller 113. The blades 114 are located along roller 112 to slit the web 80 longitudinally along the non-adhesive areas between adjacent adhesive areas of the web 80. After the web 80 is slit by the blades 114 of roller 112, the web 80 is now three separate adjacent lengths. The three lengths of web 80 are then wound around wind-up roller 110. This process continues until there are multiple wraps of the web 80 around the wind-up roller 110 to form rolls 88a, 88b, 88c.

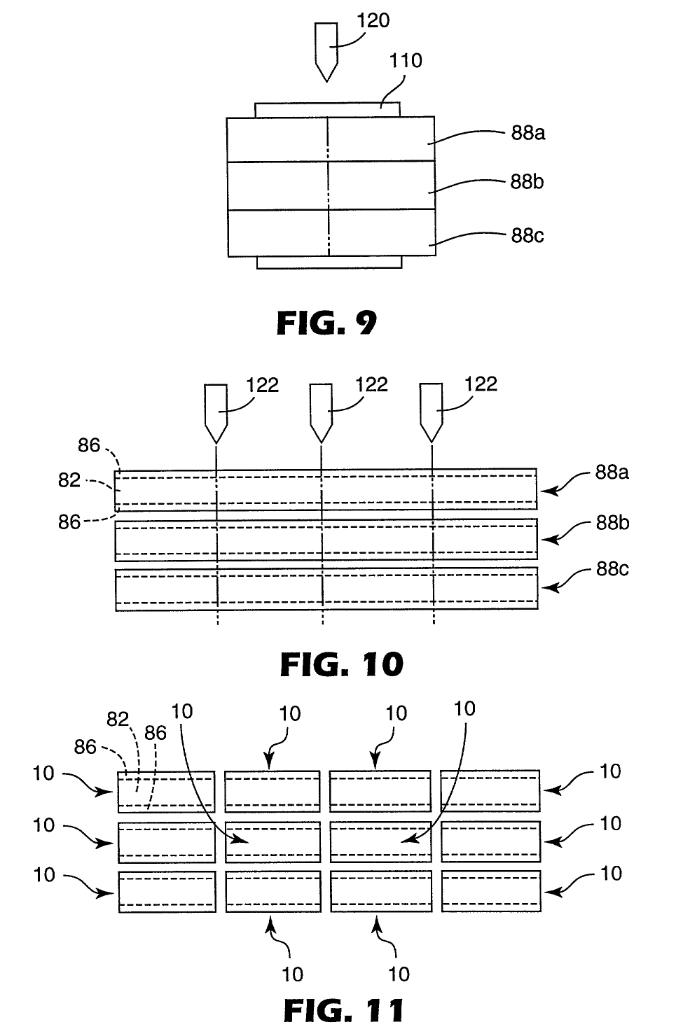

As seen in FIG. 9, after multiple layers of the web 80 have been wound around the roller 110 into rolls 88a, 88b, 88c, the rolls are cut transversely, which can be done manually with a utility knife 120 or by an automated cutter 120. The cut rolls 88a, 88b, 88c are then removed from the roller 110 and generally flattened to provide three lengths of stacked web material, as illustrated in FIG. 10. Next, the three lengths of stacked web material are cut transversely with a cutting device 122 to provide multiple stacks of adhesive articles 10, which are illustrated in FIGS. 1 and 6a. The number of carried adhesive articles in a stack corresponds to the number of layers of web wound into each roll 88. (The stack of carried adhesive articles is not to scale.)

FIGS. 12 and 13 illustrate an alternative apparatus 100′ for making the stack of carried adhesive articles 10 illustrated in FIG. 6b, which include tabs 50. The apparatus 100′ is the same as the apparatus 100, except that it includes two free rotating rollers 91 of tab material 90. The rollers 91 of tab material 90 are located above wind-up roller 110 so that each feed a continuous length of tab material onto the web 132 wound around the roller 110, along the longitudinal edges of the web 80′, as the roller 110 rotates. Alternatively, the rollers 91 may be positioned to feed tab material 90 onto the web 80′ before idler roller 116. The slitting roller 112 also has only one blade 114. The web 80′ has adhesive 82 coated across the entire width of the web 80′ and does not have any non-adhesive zones. As the web 80′ is feed between in the nip between the blade 114 of slitting roller 112 and the roller 113, the blade 114 slits the web into two separate lengths. Next, two lengths of web 80′ are then wound around wind-up roller 110. This process continues until there are multiple wraps of the web 80′ around the wind-up roller 110 to form rolls 132a, 132b. Then, the rolls 132a, 132b are cut transversely with a utility knife 120 or by an automated cutter 120, as generally illustrated in FIG. 9. The cut rolls 132a, 132b are then removed from the roller 110 and flattened to provide two lengths of stacked web material, as similarly illustrated in FIG. 10, except that each length has tab material 90 running along one longitudinal edge. Next, the two lengths of stacked web material are cut transversely with a cutting device 122 to provide multiple stacks of adhesive articles 10, which are illustrated in FIG. 6b.

One preferred method of making the stack of adhesive articles illustrated in FIG. 1 is as follows: Using the apparatus 100 illustrated in FIGS. 7 and 8. the starting web material 80 could be an adhesive transfer tape, such as the adhesive transfer tape which is commercially available in various widths and lengths from Minnesota Mining and Manufacturing, based in St. Paul, Minn., under the trade name Extended Liner Tape 465XL. The Extended Liner Tape 465XL has a clear adhesive layer for the adhesive article. Specifically, the adhesive layer 82 has approximately 0.002 inches (0.05 mm) of acrylic pressure sensitive adhesive. The carrier layer 84 is a silicone-coated, kraft paper liner, which is approximately 0.0035 inches (0.089 mm) thick. Both sides of the kraft paper liner are coated with silicone. The adhesive layer of the Extended Liner Tape is releasably adhered to the kraft paper liner and therefore, the adhesive layer may be easily removed from the liner. The approximate width of the Extended Liner Tape is 6.75 inches (17.15 cm). The Extended Liner Tape has two non-adhesive zones 86 along the longitudinal edges of the tape, which are each approximately 0.25 inches (0.64 cm) wide. The adhesive layer 82 is coated in selected areas (“zone coated”) onto the kraft paper liner to provide areas of adhesive 82 and areas of non-adhesive 86, similar to the web 80 illustrated in FIG. 8. The areas of adhesive 82 are each approximately 2 inches (5.1 cm) wide.

The web 80 can be first wound around unwind roller 118, as illustrated in FIG. 7. Then, the web 80 is pulled around idler 116 and fed through the nip formed between the slitting roller 114 and roller 113. After exiting the slitting roller 114 and roller 113, the slit web 80 is wound around the wind-up roller 110. The drive motor 111 may be started and the web 80 is pulled through the slitter roller 114 and roller 113, slitting the web 80 into three separate lengths along the two non-adhesive zones 86. The three lengths of web 80 are then wound around the wind-up roller 110. After all of the web 80 had been slit and wound into multiple layers around the wind-up roller to form three rolls 88a, 88b, and 88c, the drive motor 111 may be turned off. Next, the rolls are cut in the transverse direction with a utility knife 120 or an automated cutter 120, parallel to the axis of the wind-up roller 111, as illustrated in FIG. 9. The cut rolls 88a, 88b, 88c are removed from the wind-up roller 110, and generally flattened out, as illustrated in FIG. 10. Lastly, the cut rolls 88a, 88b, 88c are fed into a cutting device 122, where they are cut transversely to the desired length to form the stack of adhesive articles 10, illustrated in FIG. 1. The approximate dimensions of the final stack of adhesive articles can be 3 inches (7.62 cm) in length by 2.25 inches (5.72 cm) wide, with a thickness of 0.125 inches (0.318 cm).

One preferred method of making the stack of adhesive articles 10 illustrated in FIG. 6a is by following the same process outlined above, except using a different starting web material, such as a laminating adhesive. One such laminating adhesive is commercially available in various widths and lengths, from Minnesota Mining and Manufacturing, based in St. Paul Minn., under the trade name Scotch™ 9690 Laminating Adhesive. The laminating adhesive has a first layer 70 and a second layer 72 of high-strength acrylic pressure sensitive adhesive. The approximate thickness of the first and second layer of adhesive is 0.00225 inches (0.057 mm). The third layer 76 is a 0.0005 inches (0.013 mm) thick polyester film. The carrier layer 84 is a 0.0065 inches (0.165 mm) polycoated kraft release liner. The adhesive layer of is releasably adhered to the kraft paper liner and therefore, the adhesive layer may be easily removed from the liner.

The operation of the present invention will be further described with regard to the following detailed examples. These examples are offered to further illustrate the various specific and preferred embodiments and techniques. It should be understood, however, that many variations and modifications may be made while remaining within the scope of the present invention.

### EXAMPLE 1

A first example was produced on an apparatus similar to the apparatus 100 illustrated in FIGS. 7 and 8 to make a stack of adhesive articles 10 illustrated in FIG. 6a. The starting web material 80 for this example was prepared by first obtaining a roll of two-sided splice tape including a repulpable acrylic pressure sensitive adhesive, which is commercially available from Minnesota Mining and Manufacturing, based in St. Paul, Minn., under the trade name 3M™ Repulpable Double Coated Splicing Tape 9069. The double coated splicing tape has an adhesive layer 82 for the adhesive article. Specifically, the adhesive is a repulpable acrylic pressure sensitive adhesive. The adhesive layer has a first layer 70, a second layer 72, and a tissue paper for the third layer 76, located between the first layer and second layer. The carrier layer 84 was a silicone-coated, kraft paper liner. Both sides of the kraft paper liner were coated with silicone. The adhesive layer of double coated splicing tape is releasably adhered to the kraft paper liner and therefore, the adhesive layer may be easily removed from the liner. The double coated splicing tape had an approximate thickness of was 0.003 inches (0.08 mm) and an 11 inch (27.94 cm) width.

The input web material for this example did not have any non-adhesive areas 86 like the web material in the first example. Therefore, a Siat™ narrow web slitter, commercially available from Siat S.p.A., based in Italy, which includes rotary knives, was used to score and remove selected areas of the double coated adhesive layer from the carrier layer. Using the 11 inch wide input material, two central areas and both edges were stripped of adhesive material 0.5 inch (1.27 cm) wide, leaving three 3 inch (7.62 cm) wide zones of coated web adhesive, separated by non adhesive areas of liner. Also, in the process, the web was slit to a total width of 10.5 inches (26.67 cm) leaving two longitudinal edge areas of 0.25 inch (0.635 cm) wide, each without adhesive. The web 80 was then wound into a master roll with the adhesive wound to the inside.

Next, the apparatus 100 illustrated in FIGS. 7 and 8 was used to further process the master roll of converted double coated splicing tape from the previous step. One layer of preprinted back sheet material was first wound onto the wind-up roller 110 with the release side facing up, ready to accept the adhesive layer from the input web material 80. The master roll of converted double coated splicing tape was then mounted onto the unwind roller 118. The web 80 then traveled through the apparatus 100, being slit in the machine direction in the two central uncoated areas of the web, and wound around wind up roller 110 to obtain multiple layers of the web, releasably adhered to the one layer of the back sheet material. Once the desired number of layers was wound onto the wind up roller 110, a cut was made in the cross direction as shown in FIG. 9 with an automated cutter 120, parallel to the axis of the cylinder, through all layers of the wound material, to release it from the wind up roller 110. The cut rolls 88a, 88b, 88c were removed from the wind-up roller 111, and generally flattened out, as illustrated in FIG. 10. Lastly, the cut rolls 88a, 88b, 88c were fed into a guillotine 122, where they were cut transversely to the desired length to form the stack of adhesive articles 10, illustrated in FIG. 6a. The approximate dimensions of the final stack of adhesive articles were 2 inches (5.1 cm) in length by 3.5 inches (8.89 cm) wide, with a thickness of 0.125 inches (0.318 cm). The final stack of adhesive articles contained a total of twenty five adhesive articles and twenty six carrier sheets.

### EXAMPLE 2

A second example was produced on an apparatus similar to the apparatus 100′ illustrated in FIGS. 12 and 13 to make a stack of adhesive articles 10 illustrated in FIG. 6b. The starting web material 80′ was a roll of fibered adhesive transfer tape which is commercially available in various widths and lengths from Minnesota Mining and Manufacturing, based in St. Paul Minn. under the trade name High Tack Adhesive Transfer Tape 950. The adhesive transfer tape was a clear adhesive layer 82, with approximately 0.005 inches (0.13 mm) of acrylic pressure sensitive adhesive reinforced with fiberglass fibers. The carrier layer 82 was a tan colored release liner 0.004 inches (0.10 mm) thick densified kraft liner. Both sides of the kraft paper liner were coated with silicone. The web 80′ was 12 inch (30.48 cm) wide. The web 80′ did not have any non-adhesive areas 86.

The apparatus 100′ illustrated in FIGS. 12 and 13 was used to make the stack of adhesive articles 10 of FIG. 6b. One layer of preprinted back sheet material was first wound onto the wind-up roller 110 with the release side facing up, ready to accept the adhesive layer from the input web material 80′. The roll of fibered adhesive transfer tape adhesive was mounted on the unwind roller 118 illustrated in FIG. 12 and traveled in the machine direction to the windup roller 110. On both edges of the 12 inch (30.48 cm) wide web 80′, a 0.75 inch (1.91 cm) wide, paper strip 90, which was coated on both sides with silicone, was added for tabbing the final stack of adhesive articles 10. The web 80′ was slit in half at the center point of the 12 inch (30.48 cm) wide tape web, forming two 5.25 inch (13.34 cm) adhesive exposed halves with 0.75 inch (1.91 cm) paper strip edges. The web 80′ and paper strip 90 were then wound around the wind up roller 110 to form multiple layers, releasably adhered to the one layer of back sheet material. Once the desired number of layers was wound onto the wind up roller 110, a cut was made with an automated cutter 120 in the transverse direction, parallel to the axis of the roller 110, through all layers of the wound web 80′, to release it from the cylinder, as illustrated in FIG. 9. The cut rolls 132a, 132b, were removed from the wind-up roller 110, and generally flattened out, as illustrated in FIG. 10. Lastly, the cut rolls 132a, 132b were fed into a guillotine 122, where they were cut transversely to the desired length to form the stack of adhesive articles 10, illustrated in FIG. 6b. The approximate dimensions of the final stack of adhesive articles were 0.75 inches (1.91 cm) in length by 6 inches (15.24 cm) wide, with a thickness of 0.125 inches (0.318 cm). The final stack of adhesive articles contained a total of ten adhesive articles and eleven carrier sheets.

The present invention has now been described with reference to several embodiments thereof. The foregoing detailed description and examples have been given for clarity of understanding only. No unnecessary limitations are to be understood therefrom. All patents and patent applications cited herein are hereby incorporated by reference. It will be apparent to those skilled in the art that many changes can be made in the embodiments described without departing from the scope of the invention. Thus, the scope of the present invention should not be limited to the exact details and structures described herein, but rather by the structures described by the language of the claims, and the equivalents of those structures.

What is claimed is:

1. A stack of adhesive articles, comprising:
a) a first carrier sheet;
b) a first adhesive article releaseably adhered to said first carrier sheet;
c) a second carrier sheet releaseably adhered to said first adhesive article opposite said first carrier sheet;
d) a second adhesive article releaseably adhered to said second carrier sheet opposite said first adhesive article; and
e) a third carrier sheet releaseably adhered to said second adhesive article opposite said second carrier sheet.

2. The stack of adhesive articles of claim 1, wherein said first adhesive article is an adhesive layer.

3. The stack of adhesive articles of claim 2, wherein said adhesive layer comprises a pressure-sensitive adhesive.

4. The stack of adhesive articles of claim 2, wherein said adhesive layer is a reinforced adhesive layer.

5. The stack of adhesive articles of claim 4, wherein said reinforced adhesive includes fibers therein.

6. The stack of adhesive articles of claim 2, wherein said adhesive layer includes a first adhesive layer, a second adhesive layer, and a non-woven layer between said first adhesive layer and said second adhesive layer.

7. The stack of adhesive articles of claim 2, wherein said adhesive layer includes a first adhesive layer, a second adhesive layer, and a layer of film between said first adhesive layer and said second adhesive layer.

8. The stack of adhesive articles of claim 1, further comprising a first tab releasably adhered to said first adhesive article.

9. The stack of adhesive articles of claim 1, wherein said first carrier sheet and said second carrier sheet extend beyond said first adhesive article, and wherein said second carrier sheet and said third carrier sheet extend beyond said second adhesive article.

10. The stack of adhesive articles of claim 1, wherein said first adhesive article is adhered more strongly to said first carrier sheet than to said second carrier sheet.

11. The stack of adhesive articles of claim 1, wherein when said first carrier sheet is removed from said stack of adhesive articles, said first adhesive article separates from said second carrier sheet and remains releasably adhered to said first carrier sheet.

12. The stack of adhesive articles of claim 11, wherein when said second carrier sheet is removed from said stack of adhesive articles, said second adhesive article separates from said third carrier sheet and remains releasably adhered to said second carrier sheet.

13. The stack of adhesive articles of claim 1, wherein said first carrier sheet is a first release sheet and second carrier sheet is a second release sheet.

14. The stack of adhesive articles of claim 13, wherein said first release sheet and second release sheet include a release coating thereon.

15. The stack of adhesive articles of claim 14, wherein said first release sheet and said second release sheet both include a first major surface and a second major surface opposite said first major surface, and wherein said first major surface and said second major surface include a release coating thereon.

16. A stack of adhesive articles, comprising:
a plurality of carried adhesive articles, wherein each carried adhesive article includes a carrier sheet and an adhesive article releasably adhered to said carrier sheet, and
wherein each carried adhesive article is releasably adhered to said carrier sheet of an adjacent carried adhesive article.

17. The stack of adhesive articles of claim 16, wherein each of said adhesive articles is an adhesive layer.

18. The stack of adhesive articles of claim 17, wherein each of said adhesive layers comprises a pressure-sensitive adhesive.

19. The stack of adhesive articles of claim 17, wherein each of said adhesive layers is a reinforced adhesive.

20. The stack of adhesive articles of claim 19, wherein said reinforced adhesive layer includes fibers therein.

21. The stack of adhesive articles of claim 17, wherein said adhesive layer includes a first adhesive layer, a second adhesive layer, and a non-woven layer between said first adhesive layer and said second adhesive layer.

22. The stack of adhesive articles of claim 17, wherein said adhesive layer includes a first adhesive layer, a second adhesive layer, and a layer of film between said first adhesive layer and said second adhesive layer.

23. The stack of adhesive articles of claim 16, wherein said each of carried adhesive articles further comprises a tab releasably adhered to said adhesive article.

24. The stack of adhesive articles of claim 16, wherein each of said carrier sheets extends beyond said adhesive article.

25. The stack of adhesive articles of claim 16, wherein the releasable bond between the carrier sheet and the adhesive article is stronger than the releasable bond between adjacent carried adhesive articles.

26. The stack of adhesive articles of claim 16, wherein each of said carrier sheets is a release sheet, and wherein said release sheet includes a release coating thereon.

27. The stack of adhesive articles of claim 26, wherein said release sheet includes a first major surface and a second major surface opposite said first major surface, and wherein said first major surface and said second major surface include a release coating thereon.

28. A method of applying an adhesive article to a surface, comprising:
a) providing a stack of carried adhesive articles, comprising:
i) a first carrier sheet;
ii) a first adhesive article releaseably adhered to said first carrier sheet;
iii) a second carrier sheet releaseably adhered to said first adhesive article opposite said first carrier sheet;
iv) a second adhesive article releaseably adhered to said second carrier sheet opposite said adhesive article; and
v) a third carrier sheet releaseably adhered to said second adhesive article opposite said second carrier sheet;
b) removing said first carrier sheet and said first adhesive article together from said second carrier sheet;
c) adhering said first adhesive article to a surface; and
d) thereafter separating said first carrier sheet from said first adhesive article on said surface.

29. The method of claim 28, further comprising:
e) removing said second carrier sheet and said second adhesive article together from said third carrier sheet;
f) adhering said second adhesive article to said surface; and
g) thereafter separating said second carrier sheet from said second adhesive article on said surface.

30. A method of applying an adhesive article to a surface, comprising:
a) providing a plurality of carried adhesive articles, wherein each carried adhesive article includes a carrier sheet and an adhesive article releasably adhered to said carrier sheet, wherein each carried adhesive article is releasably adhered to said carrier sheet of an adjacent carried adhesive article;
b) removing one of said plurality of carried adhesive articles from said plurality of carried adhesive articles;
c) adhering said adhesive article to a surface; and
d) thereafter separating said carrier sheet from said adhesive article on said surface.

31. The method of claim 30, further comprising:
e) removing another of said plurality of carried adhesive articles from said plurality of carried adhesive articles;
f) adhering said adhesive article to a surface; and
g) thereafter separating said carrier sheet from said adhesive article on said surface.

32. A method of applying a adhesive article to a surface, comprising:
a) providing a stack of adhesive articles, comprising:
i) a first carrier sheet;
ii) a first adhesive article releaseably adhered to said first carrier sheet;
iii) a second carrier sheet releaseably adhered to said first adhesive article opposite said first carrier sheet;
iv) a second adhesive article releaseably adhered to said second carrier sheet opposite said adhesive article; and
v) a third carrier sheet releaseably adhered to said second adhesive article opposite said second carrier sheet;
b) removing said first carrier sheet from said first adhesive article;
c) adhering said first adhesive article of said stack of carried adhesive articles to a surface; and
d) thereafter separating said stack of carried adhesive articles from said first adhesive article on said surface.

33. The method of claim 32, further comprising:
e) removing said second carrier sheet from said second adhesive article;
f) adhering said second adhesive article of said stack of carried adhesive articles to said surface; and
g) thereafter separating said stack of carried adhesive articles from said second adhesive article on said surface.
